(19) United States
(12) Patent Application Publication
(10) Pub. No.: US 2016/0321524 A1
(43) Pub. Date: Nov. 3, 2016

(54) LOCATION BASED PRINT CONTROLLER WITH EXTERNAL DATA FOR AMENITIES

(71) Applicant: REALTYMAPS, LLC, Naples, FL (US)

(72) Inventors: Jon Rubinton, Naples, FL (US); Daniel Sexton, Naples, FL (US)

(21) Appl. No.: 15/071,333

(22) Filed: Mar. 16, 2016

Related U.S. Application Data
(60) Provisional application No. 62/154,118, filed on Apr. 29, 2015.
(60) Provisional application No. 62/187,332, filed on Jul. 1, 2015.
(60) Provisional application No. 62/190,961, filed on Jul. 10, 2015.
(60) Provisional application No. 62/206,701, filed on Aug. 18, 2015.
(60) Provisional application No. 62/206,710, filed on Aug. 18, 2015.

(51) Int. Cl. G06K 15/02; G06Q 50/16; G06Q 10/08; G06F 17/30; H04W 4/02

(52) U.S. Cl. CPC G06K 15/1802; G06F 17/30241; G06K 15/1819; H04W 4/021; G06Q 10/08355; G06Q 50/16

(57) ABSTRACT

The present disclosure relates to an automated printer controller for generating hardcopy artifacts based upon a geospatial designation and data layers. More specifically, the present invention includes a print controller that receives a determination of a geospatial designation and associates the geospatial designation with geographic boundaries and further associates the geographic boundaries with a parcel and at least one external data layer related to amenities in order to generate a physical artifact based upon, and specific to, the data layer, the geographic boundaries, and the parcel.

### CROSS REFERENCE TO RELATED APPLICATIONS

The present application claims the benefit of provisional patent application Ser. No. 62/154,118 filed Apr. 29, 2015 and entitled APPARATUS AND METHODS FOR TARGETED COMMUNICATION BASED ON PARCEL DATA WITH LAYERED DATA, and the benefit of provisional patent application Ser. No. 62/187,332 filed Jul. 1, 2015 and entitled PRINTER CONTROLLER FOR LOCATION BASED TARGETED ARTIFACT; and the benefit of provisional patent application Ser. No. 62/190,961 filed Jul. 10, 2015 and entitled LOCATION BASED PRINT CONTROLLER WITH EXTERNAL DATA; and the benefit of provisional patent application Ser. No. 62/206,701 filed Aug. 18, 2015 and entitled LOCATION BASED PRINT CONTROLLER WITH EXTERNAL DATA FOR AMENITIES; and the benefit of provisional patent application Ser. No. 62/206,710 filed Aug. 18, 2015 and entitled LOCATION BASED PRINT CONTROLLER WITH EXTERNAL DATA FOR GEOSPATIAL POLITICAL CONSIDERATIONS; the contents of each of which are relied upon and incorporated herein by reference.

### FIELD OF THE DISCLOSURE

The present disclosure relates to an automated printer controller. More specifically, the present invention includes a print controller that determines a geospatial designation and associates the geospatial designation with geographic boundaries and further associates the geographic boundaries with a person in order to generate a physical artifact based upon, and specific to, the geographic boundaries and the person.

### BACKGROUND OF THE DISCLOSURE

Presently, hardcopy real estate based marketing generally consists of blanket mailings based upon a zip code. A real estate agent or broker will create market awareness about the agent and perhaps a list of properties for sale by the agent.

Obvious drawbacks inherent in such a system include the open ended communication style that is not addressed to a particular individual and does not-reference a geographic area specifically associated with an individual. A marketing agent may mail out hundreds or thousands of post cards or postal pieces and not be able to ascertain whether an intended audience has received the communication or the effect of the communication unless a recipient contacts the agent.

Realtors may advertise positive attributes of offered properties in numerous manners. Realty customers may have diverse interests and desires relative to target properties. Yet, the collection and aggregation of various types of data related to parcels and their geographic area may be difficult and imprecise. One area of particular importance to potential reality customer may be the amenities that they may find in the geographic areas surrounding a particular parcel. Therefore, improvements in aggregating information about amenities and associating them with individual parcels may be desired.

Traditionally, use of parcel data and parcel maps has been limited in function and purpose. Generally, property taxes and tax databases rely on parcel maps and may provide limited historical data associated with a particular parcel. In some cases, realtors may use parcel maps in conjunction with potential.

### SUMMARY OF THE DISCLOSURE

Accordingly, the present disclosure relates to a print controller and methods of operating the print controller to generate a hardcopy based upon one or more geographic boundaries associated with a geospatial designation and one or more data layers with information specific to the geographic area. More specifically, the present disclosure describes apparatus for determining a current location of a user and relating it to a user geospatial designation. IN some embodiments, a user may specify the geospatial designation as including a current location of the user. In addition, methods of acquiring, organizing, and layering data related to a parcel, wherein a user may sort and view parcels based on layered data. The layered data may be aggregated and presented specific to a particular user. In some embodiments, the layered data may comprise data from a variety of sources, such as, for example, government databases, such as tax or census records; public databases, such as the white pages; or subscription databases, such as a multiple listing service database.

The geographic area is also associated with one or both of an individual or a legal entity (a “person”). A physical artifact, such as a printed hardcopy is generated specific to the geospatial designation and the associated person. The physical artifact may include for example, a letter or other correspondence, a contract, a marketing piece or other property specific document. In some embodiments, the physical artifact may include an image of the geospatial designation.

According to some embodiments of the present invention, a user may designate an initial geographic location, such as a particular property or neighborhood and use a device to designate a Cartesian Coordinate or a Polar Coordinate to generate location coordinates and associate a set of boundaries with the initial geographic location. A device used to designate a Cartesian Coordinate may include a device such as a Garmin™, Tom Tom™ or other mobile device. Some embodiments also allow a user to designate a tax map parcel, subdivision parcel, overhead map, or other user interactive interface to designate an initial geographic location.

The present invention therefore provides apparatus and methods for acquiring and providing information related to a geographic area, such as a real estate parcel to a user. More specifically, the present disclosure describes a method of acquiring, organizing, and layering data related to a parcel, wherein a user may sort and view parcels based on the layered data. In some embodiments, the layered data may comprise data from a variety of sources, such as, for example, government databases, such as tax or census records; public databases, such as the white pages; or subscription databases, such as a multiple listing service database.

In another aspect of the present invention, a mobile device may also include an image capture capability, and a user may take a picture of a property where the user is located or adjacent to and simultaneously record a GPS location of the user. The user may submit the user's current location and the picture to an automated apparatus practicing the present invention. The automated apparatus may receive the image and the GPS location and identify one or more geospatial designations associated with the location. The geospatial designation may include, by way of non-limiting example, one or more of: a street address, a property parcel, a neighborhood, a homeowners association, a town, a school district, a congressional district, or other geospatial designation associated with the user's current location at the time of image capture.

According to the present invention, a user may select one or more geospatial designations from the list and generate hardcopy artifacts addressed to specific to persons associated with generated geographic boundaries and a data set overlaying the geographic boundaries.

Additional embodiments may include definition of geographic area boundary based upon an area defined around an initial geographic location, such as by a radius around a point specified as the initial geographic location.

In some additional embodiments of the present invention, methods and apparatus are presented for aggregating, organizing, and layering data according to a relation to a real estate parcel and generating physical artifacts based upon aggregated data. The associated systems allow a user to sort and view parcels based on the layered data. In some embodiments, the layered data may comprise data from a variety of sources, such as, for example, government databases, such as tax or census records; public databases, such as the white pages; or subscription databases, such as a multiple listing service database.

More specifically, the present disclosure describes methods and apparatus for designating a location and at least one boundary of a geographic area linked to the location (such as real estate parcel), associating at least one overlay of data with the geographic area, and generating a physical artifact based upon a selection of the boundary and the data overlay. The physical artifact is generated specific to a Person associated with the Boundary.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates a functional diagram of a prior art system.

FIG. 1A illustrates a block diagram of geospatial designation and associated geographic boundaries.

FIG. 1B illustrates a diagram of a user with a position capture device for generating a geospatial designation.

FIG. 1C illustrates a diagram of exemplary layered data.

FIG. 2 illustrates an exemplary position capture device and interactive user interface.

FIG. 3 illustrates a block diagram of a user with a position designation device with directional capability.

FIG. 4 illustrates a flow diagram with method steps that made be executed in some implementations of the present invention.

FIG. 5 illustrates a block diagram of a relationship between a geospatial designation and multiple geographic areas.

FIG. 6 illustrates aspects of controller hardware useful for implementing the present invention as a block diagram.

FIG. 7 illustrates an exemplary processing and interface system.

FIG. 8 illustrates a block diagram of an exemplary embodiment of a mobile device.

FIG. 9 illustrates a representation of multiple geographic areas with exemplary overlays of data and Cartesian Coordinates.

FIG. 10 illustrates a representation of multiple geographic areas with exemplary department of motor vehicle overlay of data and Polar Coordinates.

FIG. 11 illustrates a representation of multiple geographic areas with exemplary amenity overlay of data and Cartesian Coordinates.

FIG. 12 illustrates a representation of a parcel map with an exemplary geographic boundary.

FIG. 13 illustrates a flow chart listing method steps that may be used to implement some embodiments of the present invention.

FIG. 14 illustrates examples of some switches that may be used to implement the present invention.

### DETAILED DESCRIPTION

The present invention provides a printer controller and methods of operating the printer controller to generate physical artifacts based upon a determined Geospatial Designation and one or more sets of boundaries associated with the Geospatial Designation. Each set of boundaries is in turn associated with a Data Layer and a Person. Upon command, the printer controller will generate an artifact specific to the Geospatial Designation and a Person predicated upon a choice of boundaries made by a user. The artifact will include information included in or derived from the Data Layer.

In some embodiments, apparatus and methods are disclosed for acquiring and providing information related to a parcel to a user. In some embodiments, the method may further comprise acquiring, organizing, and layering data related to a parcel, wherein a user may sort and view parcels based on the layered data.

In some embodiments, additional information may be aggregated and associated with one or more of: a Geospatial Designation; a set of boundaries, and a person. In some embodiments, methods of the invention may further include acquiring, organizing, and layering data related to a set of boundaries, such as a real estate property parcel, wherein a user may sort and view parcels and associated persons based on the layered data.

Glossary:

Data Layer: as used herein refers to a source of data with data fields disparate from other sources of data layered and on top of a Geographic Area defined by a Geographic Boundary.

Geospatial Designation: as used herein refers to an identifier of a specific point in relation to a geographic reference. Examples of a Geospatial Designation may include a spatial point system, such as a Cartesian Coordinate or a Polar Coordinate.

Geospatial Designation Identifier: as used herein refers to a device capable of identifying a Geospatial Designation, such as a point, in relation to a geographic area. Examples of a Geospatial Designation Identifier may include: a device specifically designed to provide Spatial Coordinates and a direction; an independent Global Positioning System Unit such as a Garmin™ TomTom™ or Magellan™; a smart device such as an iPhone™ or an Android™ phone. Other embodiments may include an Internet Access device such as a Personal Computer (“PC”) and an interactive graphical User Interface.

Geographic Boundary: as used herein refers to a delineation of one or more Geographic Areas.

Geographic Area: as used herein refers to an area of land mass acknowledged by an accepted authority, or a specifically delineated geographic area. By way of non-limiting example, a land mass acknowledged by an accepted authority may include an area with legal boundaries, such as a real estate parcel, a township, a city, a county, a state, a political district, such as a congressional district, a homeowner's association or other area acknowledged defined by statute or bylaw. A specifically delineated geographic area may include any area input into a user interface or otherwise defined by a User, such as, all areas within a defined distance from a specified point.

Geopolitical Area: as used herein refers to an area defined according to a political boundary, such as a township, a county, a voting district, a congressional district, a school district, or other legal boundary.

Cartesian Coordinate: as used herein refers to two coordinates that locate a point on a plane and measure its distance from either of two intersecting straight-line axes along a line parallel to the other axis.

Person: as used herein refers to an individual, a corporate entity, or other entity designated by law as a legal person.

Polar Coordinate: as used herein refers to a radius distance from an origin point and an angle from an axis. For example, a radius distance may be described in terms of a vector and an angle from an axis may be a counterclockwise angle from an X axis.

User interface or Web interface: as used herein refers to a set of graphical controls through which a user communicates with a printer controller. The user interface includes graphical controls such as button, toolbars, windows, icons, and pop-up menus, which the user can select using a mouse or keyboard to initiate required functions on the printer controller interface.

Wireless: as used herein refers to a communication protocol and hardware capable of digital communication without hardwire connections. Examples of Wireless include: Wireless Application Protocol (“WAP”) mobile or fixed devices, 3G, 4G, 5G, Bluetooth, 802.11, or other types of wireless capability.

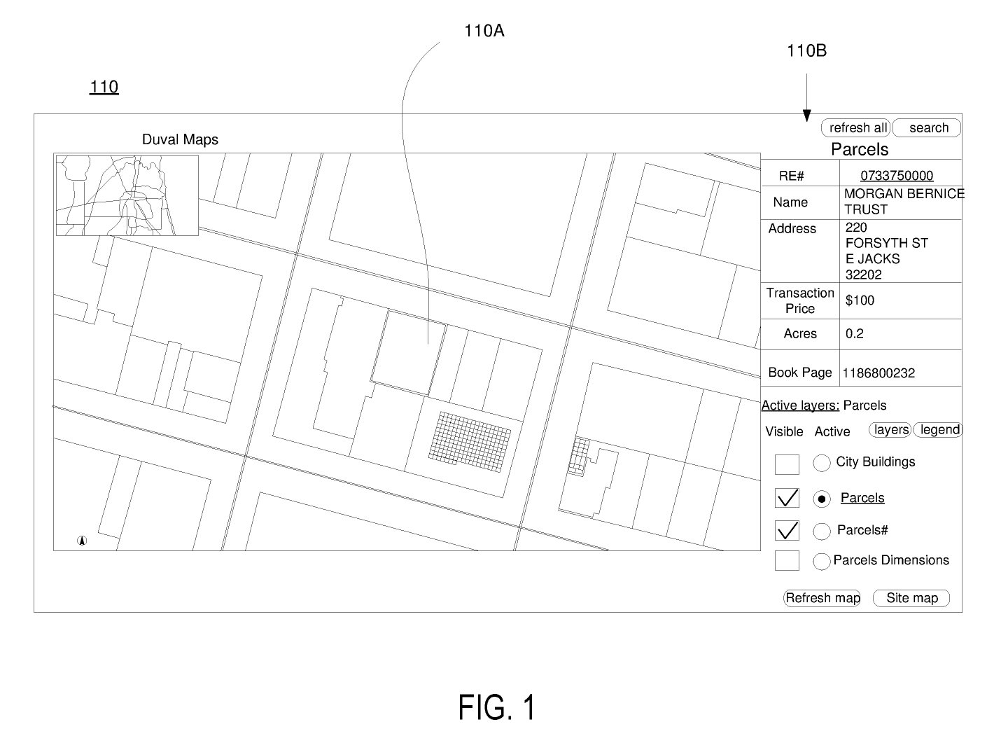

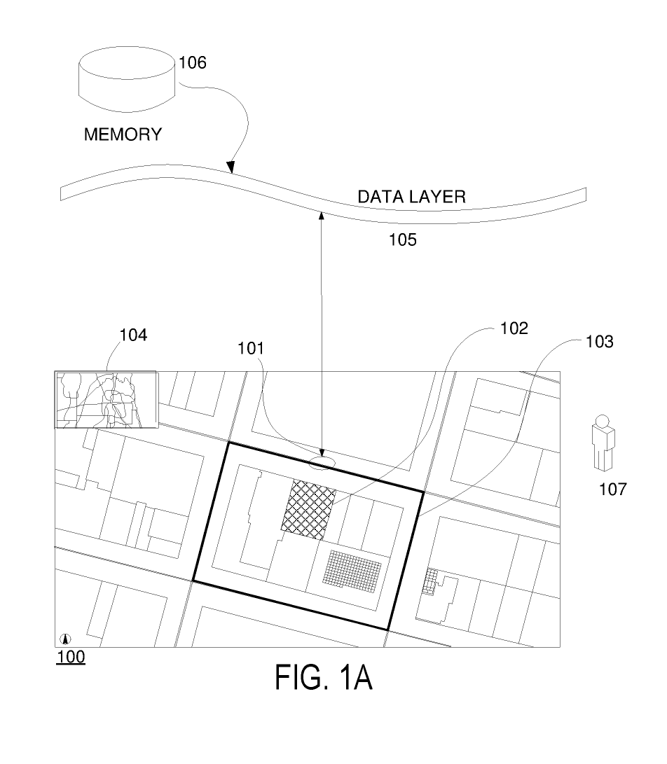

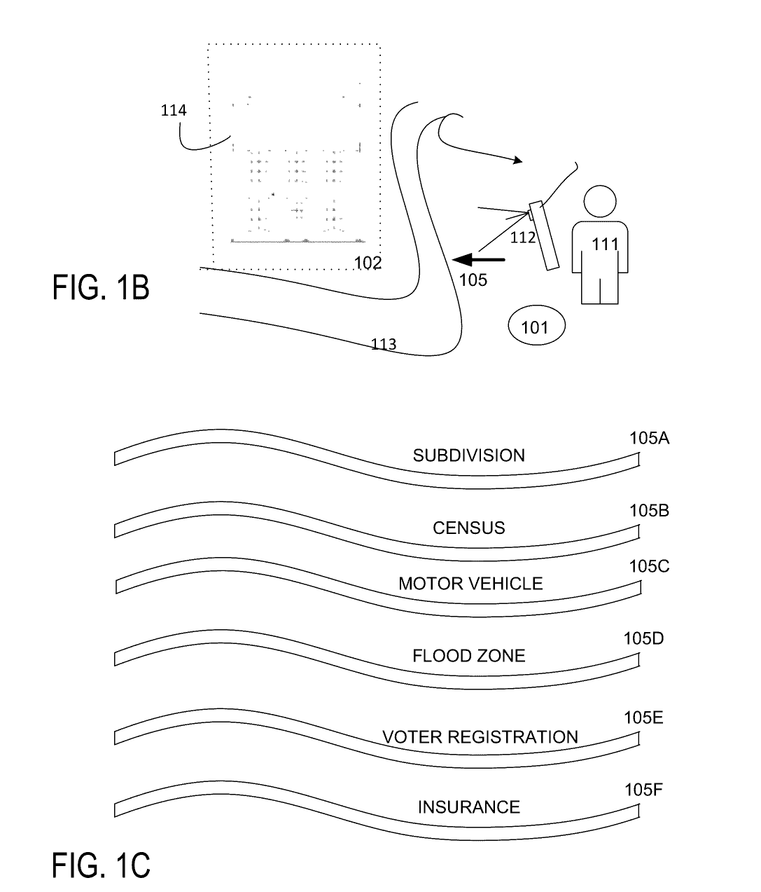

Referring now to FIG. 1, a prior art system is illustrated. In some prior art systems, a parcel map 110 may be presented in conjunction with other technical parcel data. For example, as illustrated, a highlighted parcel 110A is presented with a legend 110B with, for example, the corresponding legal description, zoning information, and an owner name.

Referring now to FIG. 1A, a functional diagram of some implementations of the present invention. According to the present invention a Geospatial Designation 101 is generated or otherwise specified by a user. As illustrated in this embodiment, the Geospatial Designation 101 is placed in the context of a real estate property parcel map 100. The Geospatial Designation 101 can be associated with one or more Geographic Areas 102-104. The Geospatial Designation 101 may be associated, for example, with one or more of: a real estate property parcel 102, a neighborhood or homeowners association 103, and another geographic or geopolitical boundary. Each Geographic Area 102-104 as defined by a Geographic Boundary 101 may be associated with a Person. A Person 107 may be an individual, a corporate entity, or other entity designated by law as a legal person.

According to the present invention, one or both of the Person 107 and the Geographic Area 102-104 is linked to at least one Data Layer 105. The Data Layer 105 may in turn be populated by logical communication with a Memory 106 storing related data. The Data Layer 105 will include fields of alphanumeric data that may be used in execution of logical calculations. Logical calculations may include cross referencing disparate data layers to determine a data set of data fields. For example, a first data layer may include information indicating how much garage space multiple Geographic Areas include and a second data layer.

As discussed further below, association may be accomplished in an interactive database system wherein a Geospatial Designation 101 may be described in a mathematical sense, such as a spatial point defining system. Examples of a spatial point defining system may include a Cartesian Coordinate system or a Polar Coordinate system with a reference.

Referring now to FIG. 1B, in some embodiments, a User 111 may operate a device that is a Geospatial Designation Identifier 112 at a point along a roadway 113 or other right of way, and generate a Geospatial Designation 101. The Geospatial Designation Identifier 112 includes the ability to provide a unique position identifier of a location that the Geospatial Designation Identifier 112 is located. A unique position identifier may include for example a Cartesian Coordinate designating a location, such as a latitude and longitude coordinate. In some embodiments, Geospatial Designation Identifier 112 may include an image capture device, wherein a User may capture a picture or other image of a Geospatial Designation 101 and simultaneously capture a Geospatial Designation 101, a direction of image capture 105, and a Field of View.

In some implementations, a subject 114 may be determined based upon the captured Geospatial Designation 101, direction of image capture 105, and Field of View. The subject may thereby be associated with a Geospatial Designation 101.

Referring now to FIG. 1C, multiple Data Layers 105A-105F may be made available, and a User may select one or more Data Layers 105A-105F to be associated with one or more of the: Geospatial Designation 101, the Geographic Area 102-104, the Person 111, and the Subject 114. In some embodiments, a Data Layer 105A-105F may be selected by the User via the Geospatial Designation Identifier 112. In other embodiments a User 111 may input a desired purpose and the Geospatial Designation Identifier 112 may associate a Data Layer 105A-105F based upon a desired purpose.

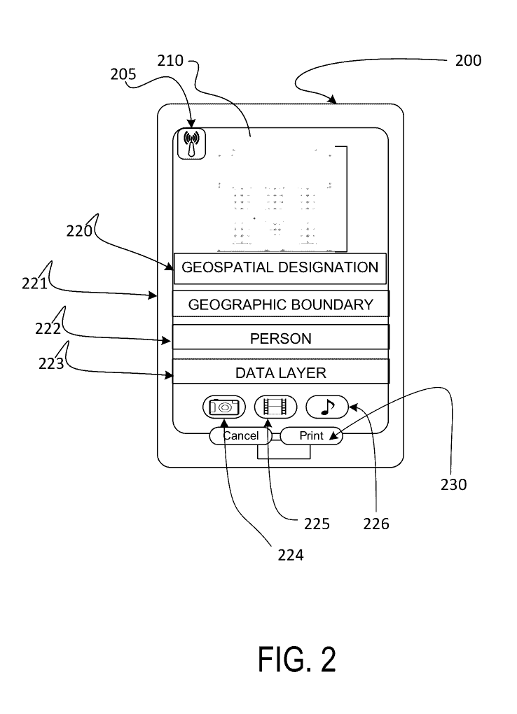

Referring now to FIG. 2, an exemplary Geospatial Designation Identifier Device 200 with functions of the Geospatial Designation Identifier Device 200 represented as a block type User Interface. It is understood by those schooled in the art that other User Interface designs, electromechanical control devices for functionality, and electronic control devices for functionality are also within the scope of the present invention. For example, a function that includes generating a Geospatial Designation 220 may be accomplished via an electromechanical switch, an electronic switch, or a programmed touchscreen.

Accordingly, in some embodiments, the Geospatial Designation Identifier 200 may include a device with User-activated functionalities 220-226 and 230. The functionalities may include a capability to generate a Geospatial Designation 220; generate a Geographic Boundary 221 associated; generate a designation of a Person associated with the Geographic Boundary 221 generated; and associate a Data Layer 223 with one or both of the Geographic Boundary 221 and the Person 222. As discussed above, in some embodiments, a Geospatial Designation Identifier 200 may also include media capture functionality 223-225 with the capability to capture one or more of: an image 223, a video 224, and an audio segment 225.

In another aspect, the Geospatial Designation Identifier 200 may also include a Wireless capability 205, such as, for example, functionality that operates in accordance with a communication protocol for digital communication. Examples of Wireless functionality may include, by way of non-limiting example, one or more of: Wireless Application Protocol (“WAP”) for mobile or fixed devices, 3G, 4G, 5G, Bluetooth, 802.11, or other types of wireless.

In still another aspect, a Geospatial Designation Identifier 200 device may include a display 210 to allow a User to view captured image data, such as a still image, picture, or a video.

Geospatial Designation Identifier 200 may therefore include a mobile device or a relatively stationary device, such as a personal computer, a laptop, or a server device configured with appropriate hardware and software to provide functionality to generate one or more of: a Geospatial Designation 220, an associated Geographic Boundary 221, and an associated Person 222. In addition, the Geospatial Designation Identifier 200 may include additional hardware and software to capture one or more of: a static image 223; multiple image frames in a video context 224; and an audio segment 225.

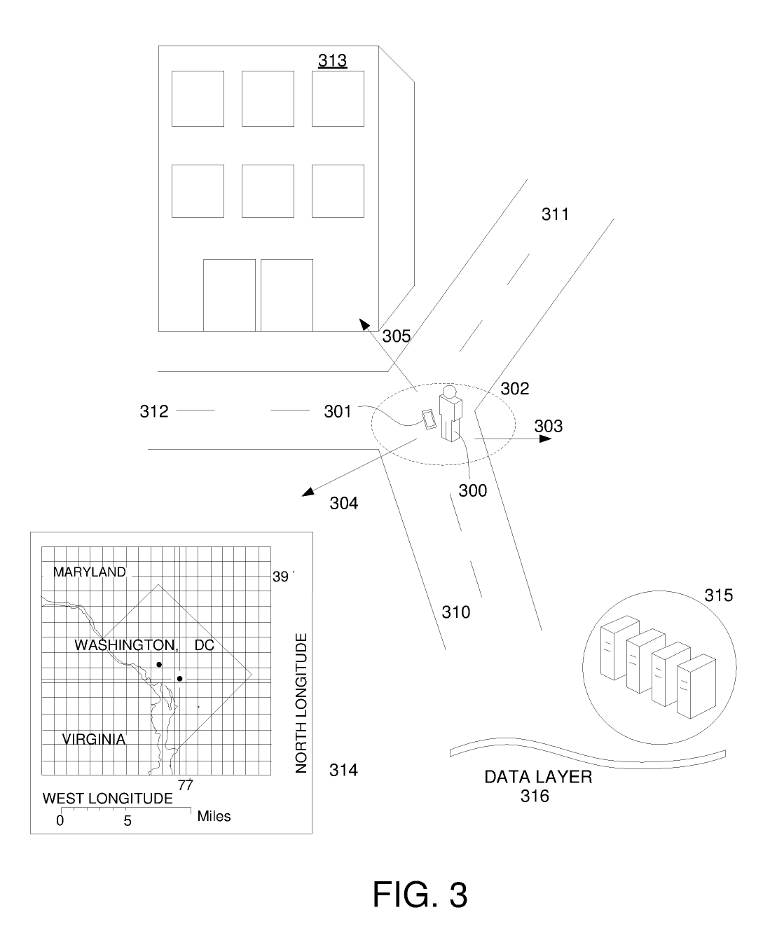

Referring now to FIG. 3, a close-up view is illustrated of a User 300 with a handheld Geospatial Designation Identifier 301 and a Geospatial Designation 302 at an intersection with three roadways or other right of way 310-312. The handheld Geospatial Designation Identifier 301 may generate a Geospatial Designation 302. The handheld Geospatial Designation Identifier 301 may also generate a direction 303-305 or receive an input from a User indicating a direction 303-305. For example, in some embodiments, a handheld Geospatial Designation Identifier 301 may include a directional indicator, such as a compass. An interface with the User may allow a user to input a direction, and the handheld Geospatial Designation Identifier 301 may correlate the input direction with mathematical representation of the input direction. The mathematical representation 314 may include, for example, a value for directional degrees and minutes and may be represented on the Geospatial Designation Identifier 301.

According to the present invention, a source of Data 315 generates a Data layer 316 specific to a Geographic Area specified by the Geospatial Designation Identifier 301. The Source of Data 315 may be a server farm with static data, or a dynamic source of data, for example data available via a communications network, such as the Internet. A Source of Data 315 may therefore include a private database, a government database, multiple listing database, a user subscription database, or other source of data.

In addition, in some embodiments, a subject 313 of an image capture may also be generated and associated with one or more of: the Geospatial Designation 302; the direction 303-305 a Geographic Area (not illustrated in FIG. 3); and a designated Person (not illustrated in FIG. 3).

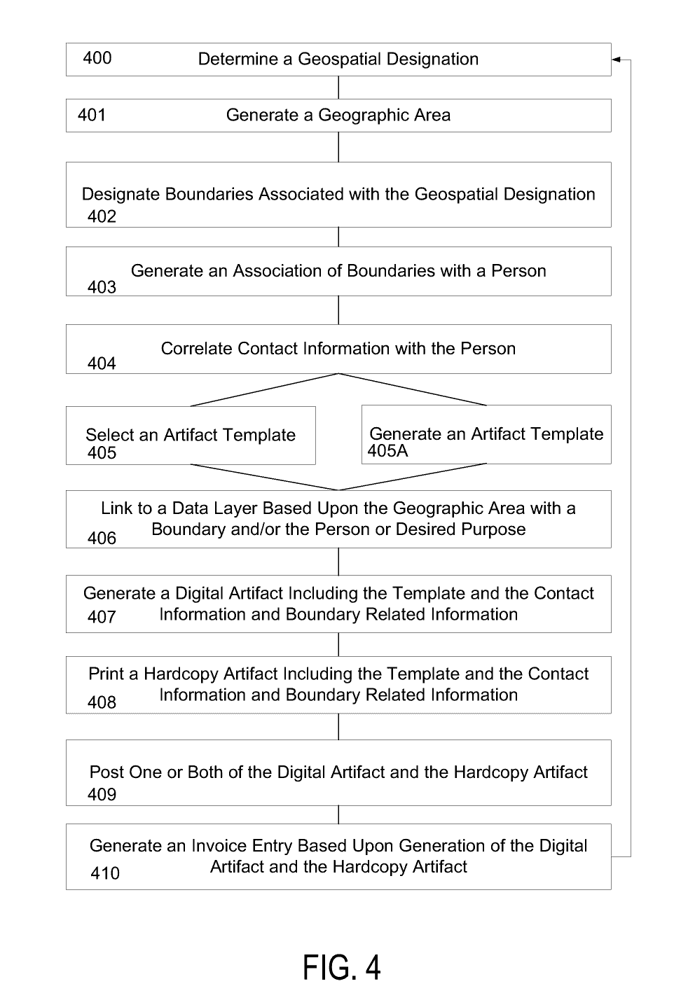

Referring now to FIG. 4, method steps that may be performed in some implementations of the present invention are listed. The method steps provided herein may be performed by one or more of: a printer controller, a special purpose computer, a Geospatial Designation Indicator, a mobile network access device, and stationary network access device. At method step 400, a Geospatial Designation may be determined. The Geospatial Designation may be determined via a Geospatial Designation Identifier device, or via a selection by a User of a point on an image, such as for example a graphical user interface with representations of one or more real estate parcels, street addresses, property lines, street intersections, and the like.

At method step 401, a Geographic Area is generated that includes the Geospatial Designation; as discussed herein, the Geographic Area, may be defined, by way of example, according to a User specified area type. The Geographic Area may be generated for example with a calculation that includes a User specified diameter, such as 0.5 miles or 5.0 miles around the Geospatial Designation. Other embodiments may include a User specified geopolitical area type associated with the Geospatial Designation, such as real estate parcel, a real estate subdivision, within specified distance from the Geospatial Designation, a homeowners association, a township, a school district, a political district, or other definable area.

At method step 402, one or more sets of Geographic Boundaries are associated with the Geographic Area including the Geographic Designation. The Geographic Boundaries may be selected via User instruction such as an alphanumeric entry or via graphical user interface menu or a point a click of a graphical image. For example, a choice of a Geographic Boundary may be made via one or more of: a drop down menu, an outline on an interactive map, an alphanumeric description, and a tax map number, a lot number in a sub-division, homeowners association, a township, a county, a state, a school district, political district, or other Geopolitical Area. In some embodiments, designation of various Geographic Boundaries may be made by linking disparate databases according to the Geographic Designation and an area included within a Geographic Boundary.

At method step 403, an association is generated of one or more of the selected Boundaries with a Person. The Person may be an individual, such as a property owner or a head of an organization, or it may be an organization, such as a corporate entity. The association of the Person with the Geographic Boundary may be generated based upon the Person's relationship with the Geographic Boundary selected by the User. In some embodiments, the association of the Person with the Boundary may be generated by linking disparate databases according to one or both the Geographic Designation and the Geographic Boundary.

At method step 404, contact information for the Person associated with the Boundary may be correlated with the Person and the associated Boundary. Contact information may be correlated via the establishment of database links in a same or disparate databases. The Contact information provides an address to which an artifact destined for the Person may be mailed. The mail may be hardcopy mail, in which case the address will include a postal address or a street address. The mail may also be digital, in which case the address may be an electronic address, such as, one or more of: an email address, a social media address, a virtual private network address, a text message address, or other electronic destination that may be associated with a person and receive an artifact.

At method steps 405 and 405A, an Artifact Template may be selected by a User 405 or generated by a User 405A. The Artifact Template will typically be a document, such as, one or more of: a letter, a contract, a sales offer, an offer to purchase, and an advertisement marketing a product or service. However, in other implementations, the present invention may generate other tangible artifacts, such as signage or an image replication.

Selection of an Artifact Template 405 may be made via a drop down list or other user interface. In some implementations, a User may provide input indicative of a purpose of the Artifact, and the Printer Controller may present options to the User based upon an indicated purpose. Other implementations may include an alphanumeric identifier of a template wherein the User may provide the identifier, and the identified Template will be combined with the Boundary information and the Person information to generate an Artifact. The Artifact Template made be generated 405A, for example, via a word processor or design or presentation software, or may be derived from a captured image such as a scanned document or image.

At method step 406, the Printer Controller or the Geospatial Designation device may link to a Data Layer based upon one or both of the Geographic Area with a Boundary and the Person associated with the Geographic Area. In addition, in some embodiments, multiple disparate data Layers may be overlaid, and a printer controller may generate an artifact including data provided from multiple data layers. In some embodiments, a User may provide a desired purpose and a Data Layer may be linked according to logic processed in the Printer Controller and/or the Geospatial Designation Identifier.

At method step 407, a Digital Artifact is generated that includes the Artifact Template and the Contact Information for the Boundary Information. The Digital artifact includes a digital representation of a desired Hardcopy Artifact that will be generated.

At method step 408, the printer controller provides instructions that cause a hardcopy artifact to be printed, or otherwise created, based upon the Artifact Template, the Contact Information, and the Boundary Related Information.

At method step 409, one or both of the Hardcopy Artifact and the Digital Artifact are submitted for delivery to the Person associated with the Boundaries via the Contact Information linked to the Person. The step of submitting for delivery may include posting a Hardcopy Artifact via a parcel carrier service or an authorized postal mail service.

At method step 410, the print server may automatically generate an invoice entry based upon the generation of one or both of: the Digital Artifact and the Hardcopy Artifact. The invoice entry may include an invoiced amount based upon one or more of: the complexity of the generation of the Digital Artifact and the Hardcopy Artifact; inclusion of an image of a Geographic Area, a size of the Digital Artifact, and/or the Hardcopy Artifact; an amount charged for delivery; a number of recipients; or other cost of goods variable.

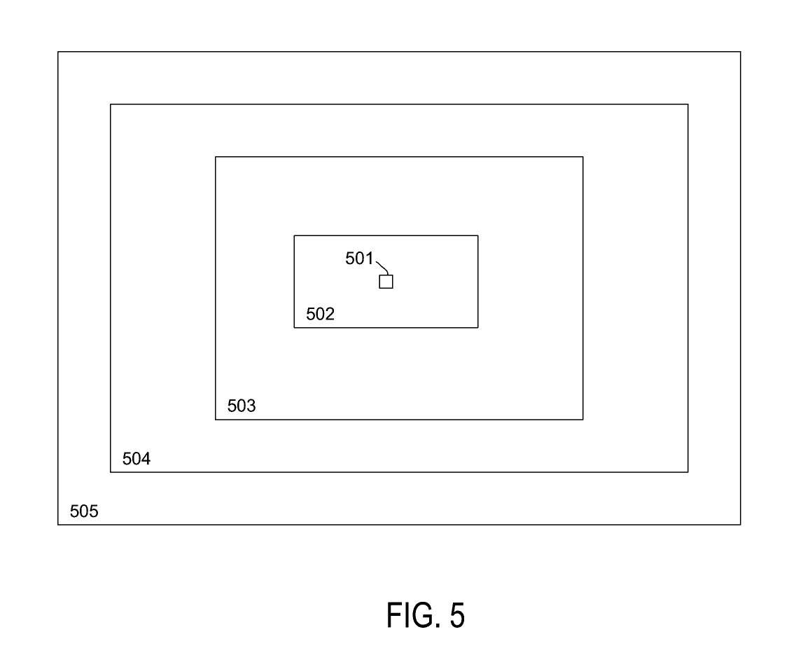

Referring now to FIG. 5, a block diagram of a Geospatial Designation 501 and multiple Geographic Areas are illustrated. The location of the Geospatial Designation 501 may be described in a mathematical sense, such as a spatial point with a base reference. In some embodiments, the location of the Geospatial Designation 501 may also be expressed in relation to one or more of the Geographic Areas. Examples of a mathematical representation of the Geospatial Designation 501 may include a Cartesian Coordinate, such as a defined latitude and longitude. Another example may include a Polar Coordinate system with a vector value in combination with a start point and an angle. A defined Cartesian Coordinate and/or the Polar Coordinate may then be associated with one or more defined areas that include point defined by the Cartesian Coordinate.

As illustrated, Geographic Areas 502-505 may include increasingly expanding areas with a smallest area 502 being a subset of one or more larger areas 503-505. Intermediate areas 503-504 may include some smaller areas 502 and be included within a larger area 505. In other embodiments, a Geographic Area 502-505 may only overlap at the point of the Geospatial Designation 501.

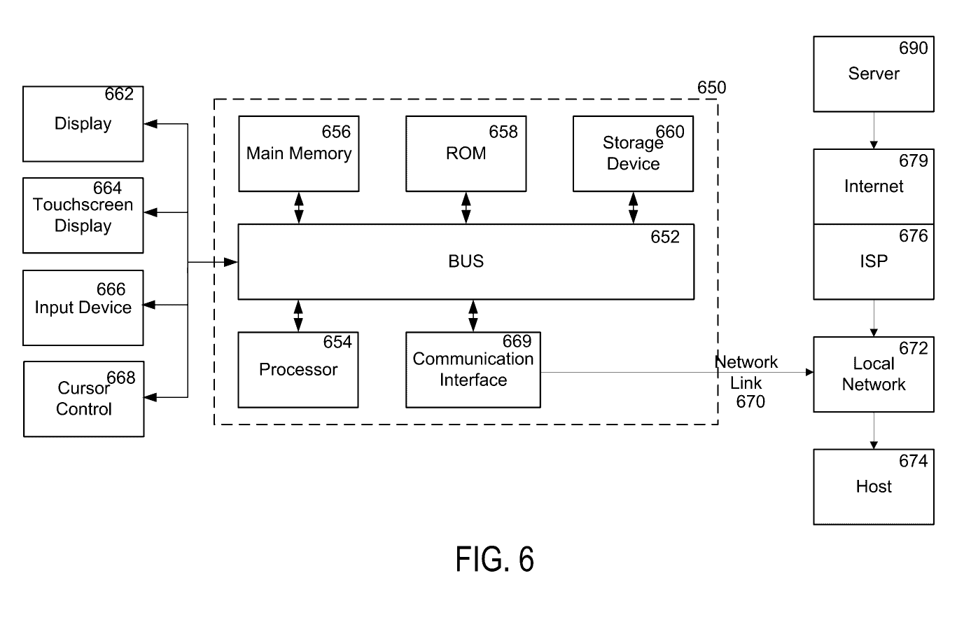

Referring now to FIG. 6, additional aspects of printer controller hardware useful for implementing the present invention are illustrated as a block diagram that includes a controller 650 upon which an embodiment of the invention may be implemented. Controller 650 includes a bus 652 or other communication mechanism for communicating information, and a processor 654 coupled with bus 652 for processing information.

Controller 650 also includes a main memory 656, such as a random access memory (RAM) or other dynamic storage device, coupled to bus 652 for storing information and instructions to be executed by processor 654. Main memory 656 may also be used for storing temporary variables or other intermediate information during execution of instructions to be executed by processor 654. Controller 650 further includes a read only memory (ROM) 658 or other static storage device 660.

Controller 650 may be coupled via bus 652 to a display 662, such as a cathode ray tube (CRT), liquid crystal display (LCD), plasma display panel (PDP), organic light-emitting diode (OLED), projector, or heads up display for displaying information to a computer user. An input device 666, including alphanumeric and other keys, may be coupled to bus 652 for communicating information and command selections to processor 654. Another type of user input device is cursor control 668, such as a mouse, a trackball, a touchpad, or cursor direction keys for communicating direction information and command selections to processor 654 and for controlling cursor movement on display 662. Another type of user input device is a touchscreen display 664 where a user may communicate information and command selections to processor 654 by tactile interaction with the display thereby controlling cursor movement or alphanumeric and other keys. This input device typically has two degrees of freedom in two axes, a first axis (e.g., x) and a second axis (e.g., y), that allows the device to specify positions in a plane.

Embodiments of the invention are related to the use of controller 650 for setting operational parameters relating to digital messaging and game playing. According to some embodiment of the invention, layering system parameters are defined and managed by controller 650 in response to processor 654 executing one or more sequences of one or more instructions contained in main memory 656. Such instructions may be read into main memory 656 from another computer-readable medium, such as storage device 660. Execution of the sequences of instructions contained in main memory 656 causes processor 654 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 654 for execution. Such a medium may take many forms, including but not limited to, non-volatile media, volatile media, and transmission media. Non-volatile media includes, for example, optical or magnetic disks, such as storage device 660 and 658. Volatile media includes dynamic memory, such as main memory 656. Transmission media includes coaxial cables, copper wire and fiber optics, including the wires that comprise bus 652. Transmission media may also take the form of acoustic or light waves, such as those generated during radio wave and infrared data communications.

Common forms of computer-readable media include, for example, a memory stick, hard disk or any other magnetic medium, a CD-ROM, any other optical medium, a RAM, a PROM, and EEPROM, any other memory chip or cartridge, or any other medium from which a computer may read.

Various forms of computer readable media may be involved in carrying one or more sequences of one or more instructions to processor 654 for execution. For example, the instructions may initially be carried on a magnetic disk of a remote computer. The remote computer can load the instructions into its dynamic memory and send the instructions over a distributed network such as the Internet. A communication device may receive the data on the telephone line, cable line, or fiber-optic line and use an infrared transmitter to convert the data to an infrared signal. An infrared detector can receive the data carried in the infrared signal and appropriate circuitry can place the data on bus 652. Bus 652 carries the data to main memory 656, from which processor 654 retrieves and executes the instructions. The instructions received by main memory 656 may optionally be stored on storage device 660 either before or after execution by processor 654.

Controller 650 also includes a communication interface 669 coupled to bus 652. Communication interface 669 provides a two-way data communication coupling to a network link 670 that may be connected to a local network 672. For example, communication interface 669 may operate according to the internet protocol. As another example, communication interface 669 may be a local area network (LAN) card allowing a data communication connection to a compatible LAN. Wireless links may also be implemented.

Network link 670 typically provides data communication through one or more networks to other data devices. For example, network link 670 provides a connection through local network 672 to a host computer 674 or to data equipment operated by an Internet Service Provider (ISP) 676. ISP 676 in turn provides data communication services through the worldwide packet data communication network now commonly referred to as the “Internet” 679. Local network 672 and Internet 679 both use electrical, electromagnetic, or optical signals that carry digital data streams. The signals through the various networks and the signals on the network link 670 and through communication interface 669, which carry the digital data to and from controller 650 are exemplary forms of carrier waves transporting the information.

In some embodiments, Controller 650 may send messages and receive data, including program code, through the network(s), network link 670 and communication interface 669. In the Internet example, a server 690 might transmit a requested code for an application program through Internet 679, ISP 676, local network 672 and communication interface 669.

Processor 654 may execute the received code as it is received, and/or stored in storage device 660, or other non-volatile storage for later execution. In this manner, controller 650 may obtain application code in the form of a carrier wave.

Access devices may include any device capable of interacting with controller or other service provider. Some exemplary devices may include a mobile phone, a smart phone, a tablet, a netbook, a notebook computer, a laptop computer, a wearable computing or electronic device, a terminal, a kiosk or other type of automated apparatus. Additional exemplary devices may include any device with a processor executing programmable commands to accomplish the steps described herein.

A controller may be a programmable board such as an Arduino board, and/or one or more of: personal computers, laptops, pad devices, mobile phone devices and workstations located locally or at remote locations, but in communication with the system. System apparatus can include digital electronic circuitry included within computer hardware, firmware, software, or in combinations thereof. Additionally, aspects of the invention can be implemented manually.

Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The present invention may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors.

Generally, a processor will receive instructions and data from a read-only memory and/or a random access memory. Generally, a computer will include one or more mass storage devices for storing data files; such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EEPROM and flash memory devices; magnetic disks such as, internal hard disks and removable disks; and CD ROM disks. Any of the foregoing can be supplemented by, or incorporated in, ASICs (application-specific integrated circuits).

In some embodiments, implementation of the features of the present invention is accomplished via digital computer utilizing uniquely defined controlling logic, wherein the controller includes an integrated network between and among the various participants in Process Instruments.

The specific hardware configuration used is not particularly critical, as long as the processing power is adequate in terms of memory, information updating, order execution, redemption and issuance. Any number of commercially available database engines may allow for substantial account coverage and expansion. The controlling logic may use a language and compiler consistent with that on a CPU included in the medical device. These selections will be set according to per se well-known conventions in the software community.

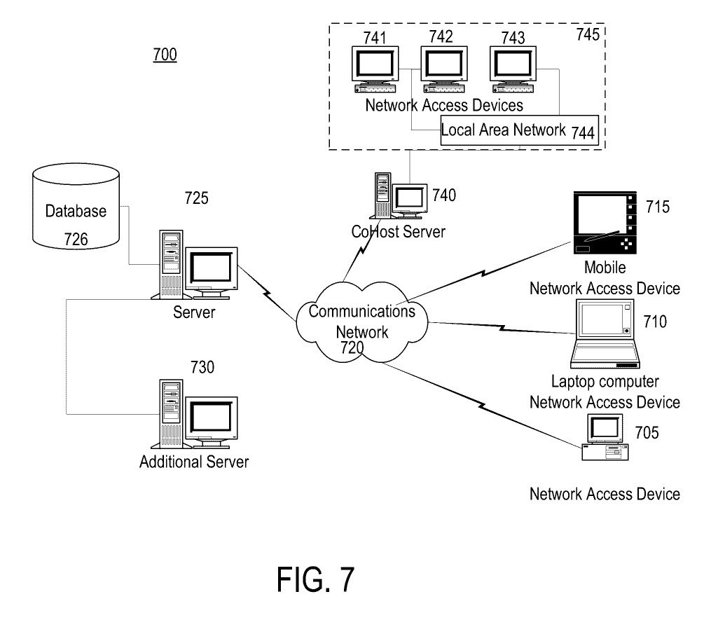

Referring now to FIG. 7, an exemplary processing and interface system 700 is illustrated. In some aspects, access devices 715, 710, 705, such as a mobile device 715 or laptop computer 710 may be able to communicate with an external server 725 though a communications network 720. The external server 725 may be in logical communication with a database 726, which may comprise data related to identification information and associated profile information. In some examples, the server 725 may be in logical communication with an additional server 730, which may comprise supplemental processing capabilities.

In some aspects, the server 725 and access devices 705, 710, 715 may be able to communicate with a cohost server 740 through a communications network 720. The cohost server 740 may be in logical communication with an internal network 745 comprising network access devices 741, 742, 743 and a local area network 744. For example, the cohost server 740 may comprise a payment service, such as PayPal or a social network, such as Facebook or a dating web site.

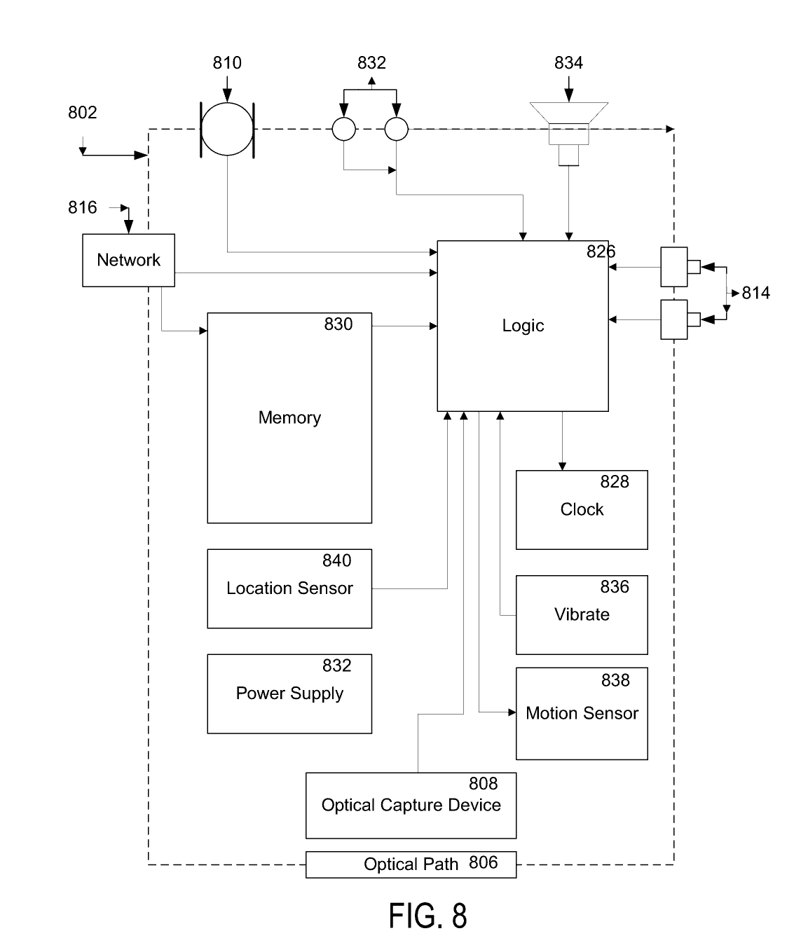

Referring now to FIG. 8, a block diagram of an exemplary embodiment of a mobile device 802 is illustrated. The mobile device 802 may comprise an optical capture device 808, which may capture an image and convert it to machine-compatible data, and an optical path 806, typically a lens, an aperture, or an image conduit to convey the image from the rendered document to the optical capture device 808. The optical capture device 808 may incorporate a Charge-Coupled Device (CCD), a Complementary Metal Oxide Semiconductor (CMOS) imaging device, or an optical sensor of another type.

In some embodiments, the mobile device 802 may comprise a microphone 810, wherein the microphone 810 and associated circuitry may convert the sound of the environment, including spoken words, into machine-compatible signals. Input facilities 814 may exist in the form of buttons, scroll-wheels, or other tactile sensors such as touch-pads. In some embodiments, input facilities 814 may include a touchscreen display. Visual feedback 832 to the user may occur through a visual display, touchscreen display, or indicator lights. Audible feedback 834 may be transmitted through a loudspeaker or other audio transducer. Tactile feedback may be provided through a vibration module 836.

In some aspects, the mobile device 802 may comprise a motion sensor 838, wherein the motion sensor 838 and associated circuitry may convert the motion of the mobile device 802 into machine-compatible signals. For example, the motion sensor 838 may comprise an accelerometer, which may be used to sense measurable physical acceleration, orientation, vibration, and other movements. In some embodiments, the motion sensor 838 may comprise a gyroscope or other device to sense different motions.

In some implementations, the mobile device 802 may comprise a location sensor 840, wherein the location sensor 840 and associated circuitry may be used to determine the location of the device. The location sensor 840 may detect Global Position System (GPS) radio signals from satellites or may also use assisted GPS where the mobile device may use a cellular network to decrease the time necessary to determine location. In some embodiments, the location sensor 840 may use radio waves to determine the distance from known radio sources such as cellular towers to determine the location of the mobile device 802. In some embodiments these radio signals may be used in addition to and/or in conjunction with GPS.

In some aspects, the mobile device 802 may comprise a logic module 826, which may place the components of the mobile device 802 into electrical and logical communication. The electrical and logical communication may allow the components to interact. Accordingly, in some embodiments, the received signals from the components may be processed into different formats and/or interpretations to allow for the logical communication. The logic module 826 may be operable to read and write data and program instructions stored in associated storage 830, such as RAM, ROM, flash, or other suitable memory. In some aspects, the logic module 826 may read a time signal from the clock unit 828. In some embodiments, the mobile device 802 may comprise an on-board power supply 832. In some embodiments, the mobile device 802 may be powered from a tethered connection to another device, such as a Universal Serial Bus (USB) connection.

In some implementations, the mobile device 802 may comprise a network interface 816, which may allow the mobile device 802 to communicate and/or receive data to a network and/or an associated computing device. The network interface 816 may provide two-way data communication. For example, the network interface 816 may operate according to an internet protocol. As another example, the network interface 816 may comprise a local area network (LAN) card, which may allow a data communication connection to a compatible LAN. As another example, the network interface 816 may comprise a cellular antenna and associated circuitry, which may allow the mobile device to communicate over standard wireless data communication networks. In some implementations, the network interface 816 may comprise a Universal Serial Bus (USB) to supply power or transmit data. In some embodiments, other wireless links known to those skilled in the art may also be implemented.

As an illustrative example of a mobile device 802, a reader may scan some text from a newspaper article with mobile device 802. The text is scanned as a bit-mapped image via the optical capture device 808. Logic 826 causes the bit-mapped image to be stored in memory 830 with an associated time-stamp read from the clock unit 828. Logic 826 may also perform optical character recognition (OCR) or other post-scan processing on the bit-mapped image to convert it to text. Logic 826 may optionally extract a signature from the image, for example by performing a convolution-like process to locate repeating occurrences of characters, symbols or objects, and determine the distance or number of other characters, symbols, or objects between these repeated elements. The reader may then upload the bit-mapped image (or text or other signature, if post-scan processing has been performed by logic 826) to an associated computer via network interface 616.

As an example of another use of mobile device 802, a reader may capture some text from an article as an audio file by using microphone 810 as an acoustic capture port. Logic 826 causes audio file to be stored in memory 828. Logic 826 may also perform voice recognition or other post-scan processing on the audio file to convert it to text. As above, the reader may then upload the audio file (or text produced by post-scan processing performed by logic 826) to an associated computer via network interface 816.

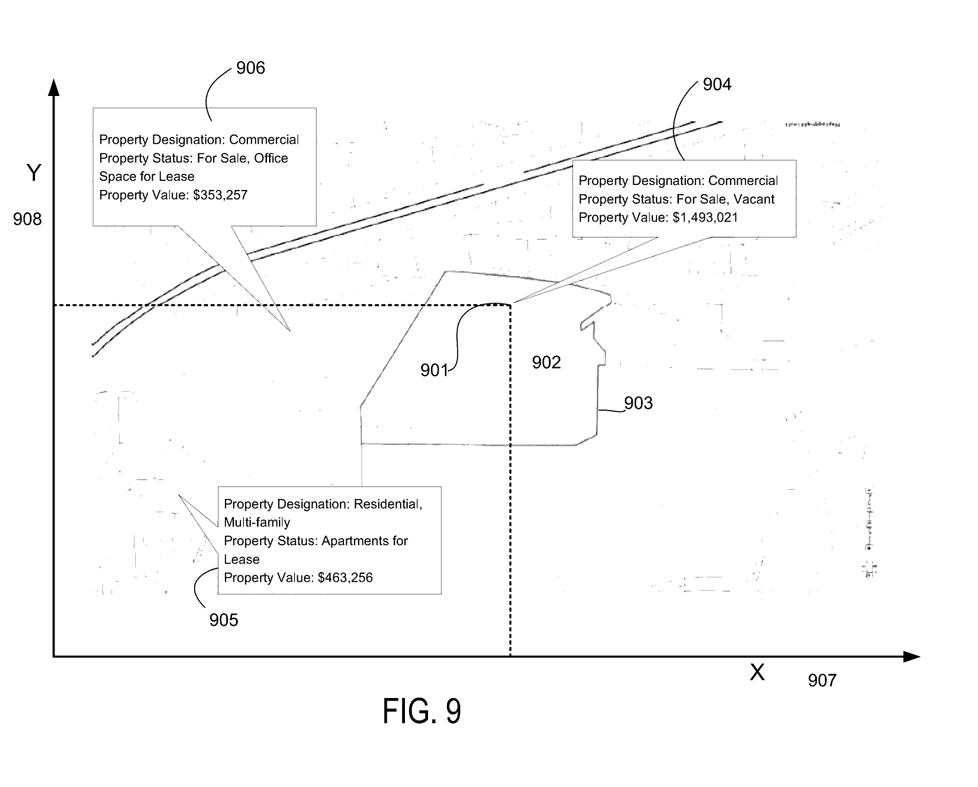

Referring now to FIG. 9, examples of information included in a Data Layer 904-905 is illustrated superimposed over a representation of multiple Geographic Areas with at least one Geographic Area 902. A User may identify a Geographic Designation 901 via a Geospatial Designation Device (not shown in this diagram). As illustrated, the Geospatial Designation 901 may be associated with a Cartesian Coordinate with a numeric value on two axis. As illustrated, the two axes include an X Axis 907 and a Y Axis 908. Other methods of identification of a location of a Geospatial Designation 901 may also be used, such as Polar Coordinates (discussed further below). In some specific embodiments, an X Axis 907 and a Y Axis 908 may include a latitude and longitude value.

A Geographic Area 902 may be defined by one or more Geographic Boundaries 903. A data overlay 904-906 may include disparate information about one or more Geographic Areas 902. An example is illustrated wherein a data layer 905-906 includes alphanumeric data descriptive of information relevant to the Geographic Area 902. The exemplary information may include a Property Designation, such as Commercial Property or Residential Property; a status of the property, such as “For Sale”, “Occupied”, “For Lease”, “Vacant”, and “Office Space for Lease”, or other descriptor of a status of a Geographic Area. In another aspect, a property value may be linked to a Geographic Area 902. The Property value may be gleaned from information provided by an Assessors Office, through a private database, or through calculation based upon the descriptors associated with the Geographic Area, such as one or more of: improvements on the property, zoning use, size of a property, amenities of property, and special characteristics, such as waterfront or an exceptional view.

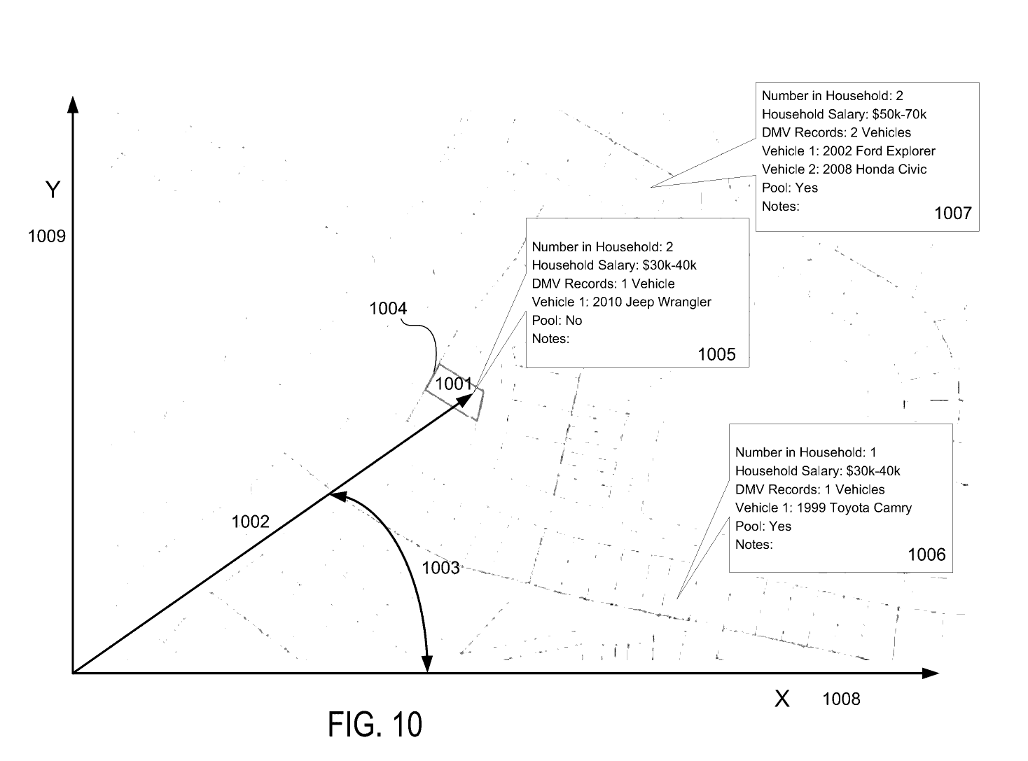

Referring now to FIG. 10, in some embodiments of the present invention, a Geographic Designation 1001 may be specified according to the terms of a Polar Coordinate. As illustrated, a Polar Coordinate may include a radius 1002 that reaches a Spatial Designation 1001. The radius 1002 will be located at an angle 1003 from an X axis 1008 towards a Y axis 1009. The origin of the radius 1001 and the X axis 1008 will be at the same point. As illustrated, data overlays 1005-1007 may be associated with a Geographic Area 1004 located according to the Spatial Designation 1001.

The data overlays include disparate data provided by: a) a State Department of Motor Vehicles, b) Census data relating to annual income, and c) information descriptive of property improvements. According to the present invention, the data overlays are associated with a Geographic Location 1004 specified by a Spatial Designation 1001. Accordingly, a description of a motor vehicle may be associated with a Cartesian Coordinate or a Polar Coordinate. Once associated with a Geographic Location 1004, the first data layer concerned with motor vehicle related data may be associated with a disparate data layer with data related to property improvements such as a pool; and further associated with a third data layer, such as household income.

There may be a very large number of data layers which may contain disparate data associated with a Geographic Area. A broad class of data layers may relate to amenities and each amenity is associated with location coordinates that essentially describe a location of the amenity. Based upon the amenity location, it that may be determined if the amenity is within the Geographic Area or accessible to a person in the Geographic Area.

In another aspect, amenities may be associated with a parcel or geographic area and may include data values associated with deeded rights of a parcel of various kinds.

In another aspect, amenities may be characterized relative to a parcel or geographic area based on distance parameters such as calculated point to point distance, driving distance, estimated driving time, estimated walking time and the like. In some examples, one or more of these calculated values may be an implicit or explicit filtering condition for association, such as for example, parcels within 10 minutes average driving time. In some examples, driving distance may be algorithmically related to a database formed from historical driving patterns of cars travelling the approximate path between the parcel and the amenity. In these examples, the database may include data values that may allow for actual driving time estimates based on historical data.

In some examples, the amenities may include natural resources. The natural resources that may be summarized into an amenities data layer may include waterfront access, lakes, rivers, hiking trails, and associated natural parks. Another related type of amenity may include community resources. In some examples, community resources may include generalized park areas. Other community resources may include locations for sporting events such as golf courses, tennis courts, hockey rinks, baseball fields, soccer fields, basketball fields, handball courts, public swimming pools, ski/snowboarding slopes, water parks, and sports or amusement parks that may contain a combination of locations for sporting events.

Another type of amenity that may be included in a data layer associated with amenities may be resources associated with business districts. In some examples, amenities related to business districts may include designation of “downtown” business areas as a collection where numerous service providers may be geographically collocated. In some examples, the designation of such an amenity within a geographic area may allow for additional possibilities of “drill down”. In some examples, identification of major employers may be considered an amenity to be included in the data layer. Downtown areas and major employers may be expected to have support aspects such as hotels, restaurants, convention centers, meeting halls and the like. In some examples, business district based amenities may also relate to government offices and agencies.

Another type of amenity that may be included in a data layer associated with amenities may be resources associated with public services these amenities may include public transportation such as trains, buses, subways, and taxi and limousine offices or stands. In some examples the data layer may contain information related to the geographic location of stations for public services and schedules and the like. In other examples there may be information related to routes for the public services as appropriate.

Another type of amenity that may be included in a data layer associated with amenities may be resources associated with public attractions. Public attractions may include malls, shopping centers, outlets, stadiums, museums, libraries, and other such locations where masses of users may be attracted for various purposes.

Another type of amenity that may be included in a data layer associated with amenities may be resources associated with municipal utilities. Municipal utilities may include services such as municipal water supply, municipal sewers, municipal gas, electrical utilities, telephone, cable and internet services and the like. In some examples, the data layer may contain indications of the service provider associated with any of these municipal utilities that may be offered at the geographic designation. In other examples, there may also be information in the layer that allows for the presentation of service “map” layers to indicate the geographic boundaries for the particular municipal service offering. Still further examples may include indications of the routing of major volumes of the municipal utility such as high voltage tension service, major buried gas line distribution, sewer access point, sewer treatment facilities and the like.

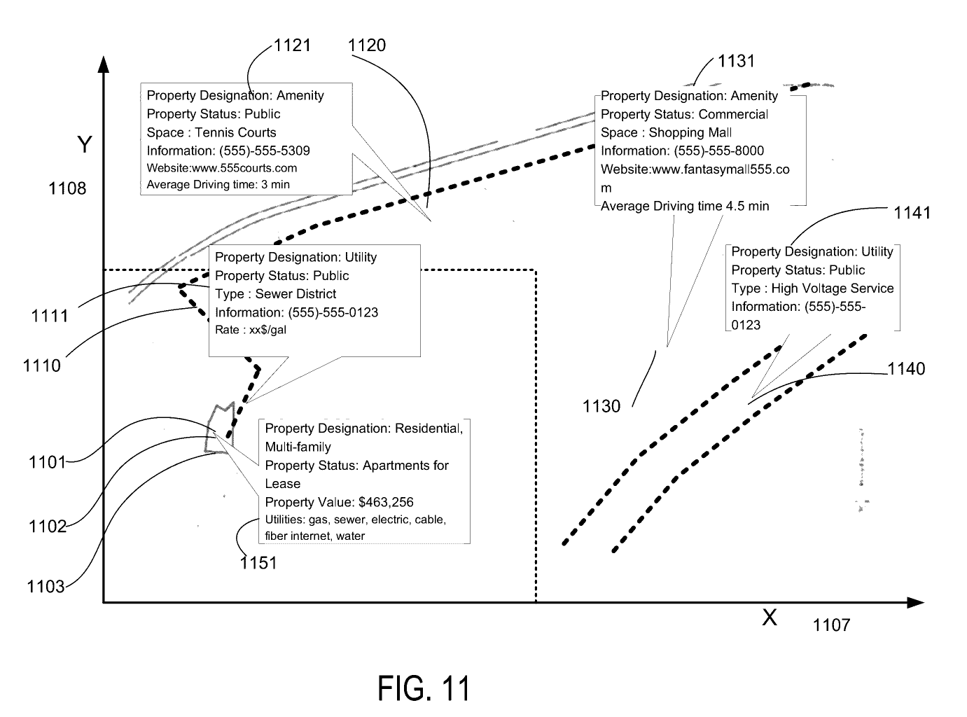

Referring now to FIG. 11, examples of information included in a Data Layer is illustrated superimposed over a representation of multiple Geographic Areas with at least one Geographic Area 1102. A User may identify a Geographic Designation 1101 via a Geospatial Designation Device (not shown in this diagram). As illustrated, the Geospatial Designation 1101 may be associated with a Cartesian Coordinate with a numeric value on two axis. As illustrated, the two axes include an X Axis 1107 and a Y Axis 1108.

A Geographic Area 1102 may be defined by one or more Geographic Boundaries 1103. A data overlay including 1111, 1121, 1131, 1141, and 1151 may include disparate information about one or more Geographic Areas 1102. An example is illustrated wherein the data layer includes alphanumeric data descriptive of information relevant to the Geographic Area 1102. In the example of 1151 the data layer may include information related to a property physically located within the Geographic Area 1102. In this example, the property designation, status, value and a listing of utility amenities may be provided. In other portions of the data layer at 1111 information relating to a Sewer Amenity 1110 may be provided geographically referenced to the Geographic Area 1102. In other portions of the data layer at 1121 information about public tennis courts 1120 may be provided. In other portions of the data layer at 1131 information about a shopping mall amenity 1130 may be provided. At another portion of the data layer a high voltage service 1140 may have information presented at 1141. The various information populating the data layer may be gleaned from information provided by government databases, through a private database, or through calculations based upon the descriptors associated with the Geographic Area, such as geographic locations of particular amenities that may be used to calculate average driving time for example.

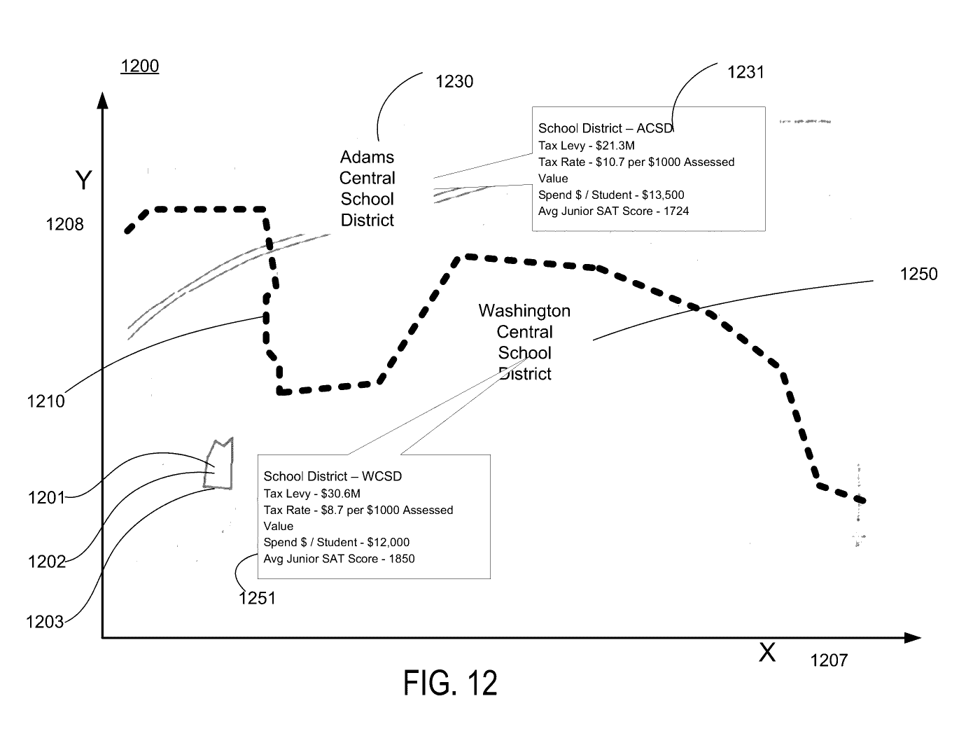

Referring now to FIG. 12, an additional example of information included in a Data Layer is illustrated superimposed over a representation of multiple Geographic Areas with at least one Geographic Area 1202. As illustrated, the Geospatial Designation 1201 may be associated with a Cartesian Coordinate with a numeric value on two axis. As illustrated, the two axis include an X Axis 1207 and a Y Axis 1208.

A Geographic Area 1202 may be defined by one or more Geographic Boundaries 1203. A data overlay including 1210 may include a presentation of a boundary line between a region associated with the Geographic Areas 1202 and other regions 1202A. An example is illustrated wherein the data layer includes a boundary between school districts. Another data overlay at 1250 and 1251 presents disparate data relative to one of the school districts. On the other side of the demonstrated boundary 1210 may be a second school district with associated data overlays at 1230 and 1231. These examples may be illustrative of the type of representations that may be possible for Geopolitical Areas.

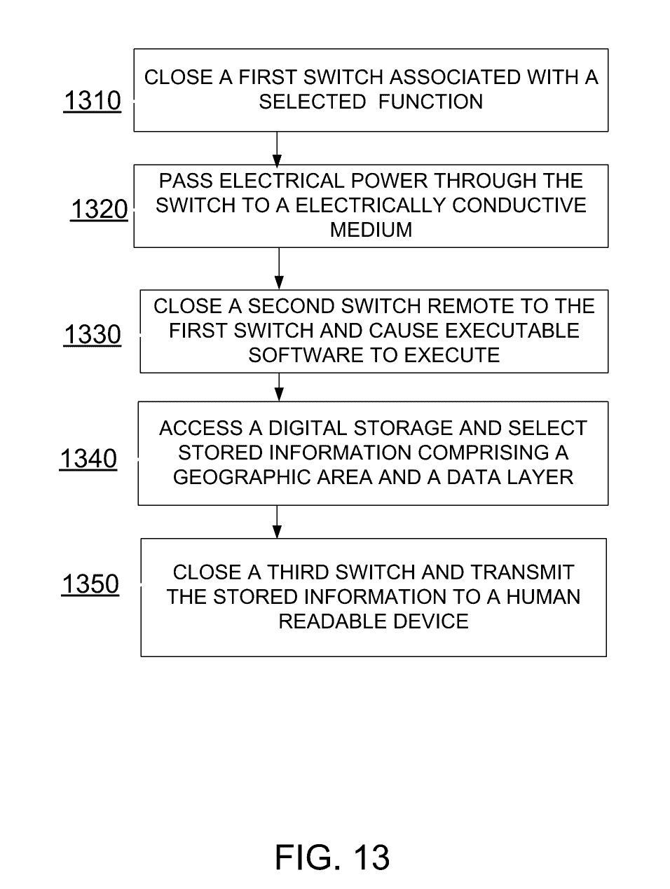

Referring now to FIG. 13, a flow chart lists method steps that may be used to implement some embodiments of the present invention. At method step 1310, a user may close a first switch associated with a selected function and at method step 1320, the closed switch enables electrical power to pass through the switch to electrically conductive medium. The electrically conductive medium may include, for example a wire, a semiconductor and/or an ambient atmosphere capable of transferring a pattern of electromagnetic energy. At method step 1330, a second switch at a location remote to the first switch may be closed may be closed. In some embodiments, the second switch will be closed based upon receipt of electrical power passed through the electrically conductive medium. Closing the second switch will cause executable software to execute.

At method step 1340, a digital storage is accessed and stored information is selected. The stored information will include a geographic area and a data layer associated with the geographic layer. In some embodiments, the digital storage is accessed by a device controlled by the executable software.

At method step 1350, a third switch is closed. Closure of the third switch permits electrical energy to cause the stored information to transmit to a human readable device.

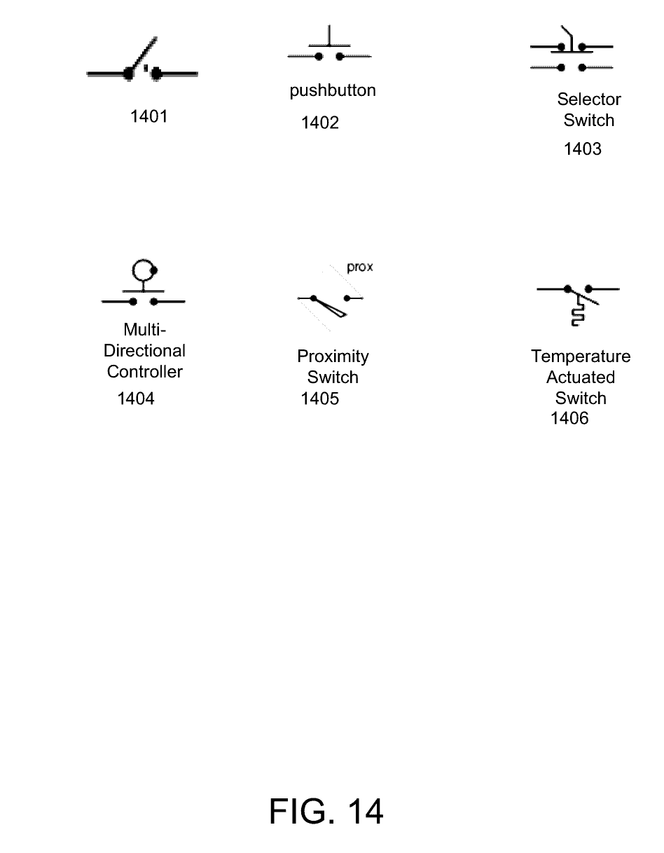

Referring now to FIG. 14, examples of some switches that may be used to implement the present invention. As used herein an electrical switch may include any device used to complete or interrupt the flow of electrons in a circuit. The switches used to toggle electron flow (current) are preferably binary devices, wherein an associated circuit is either completely on (“closed”) or completely off (“open”). However, alternative switches may include a variable switch that provides an adjustable amount of electron flow. A switch may include one or both of a mechanical switch including contacts or solid-state gate circuits as discussed further herein. Other electromechanical devices that may be used to implement various aspects of the present invention may include, one or more of: Power source; Switch; Storage; Amplifier; Transmitter; Transmission medium; Receiver; downlink; storage; switch; electrical or electromechanical device.

In general, a mechanical switch includes two electrical conductors that may be brought in contact with each other via action of an actuating mechanism. On some embodiments, switches may also include electronic circuits able to turn on or off depending on some physical stimulus (such as light or magnetic field) sensed. In any case, the final output of any switch will be (at least) a pair of wire-connection terminals that will either be connected together by the switch's internal contact mechanism (“closed”), or not connected together (“open”).

According to the present invention switches actuated by a person may include one or more of several actuating mechanisms, including the following, for example:

An electrical switch 1401 actuated by a moveable contact that placed be placed in an open state and a closed state. Open and closed states may be accomplished mechanically via one or more moveable parts into one of two or more positions. A mechanical switch may include an internal spring positioned to return the moveable contact to a home position. Mechanical switch with a spring loaded home position may sometimes be referred to as “momentary” switch or a single pulse switch.

An electrical switch 1401 may also include a Capacitive Sensing switch generally including an insulator such as glass coated with a conductor, such as indium oxide. An electrostatic field is created across the insulator and conductor, when the electrostatic field is interrupted or distorted a measurable change in capacitance may be registered. Sometimes the switch is referred to as a capacitance discharge switch. One common use of a Capacitive Sensing switch is in a touchscreen, wherein the electrostatic field is interrupted by touching a coated glass with conductive medium.

An electrical switch 1401 may also include a Resistive switch generally includes two or more electrically resistive layers separated by a relatively thin space. An upper layer includes a coating (such as on the underside) another resistive layer coats a lower layer on a surface towards the upper layer. When an object presses down on the upper layer, the upper layer, and the lower layer touch and become connected at that point. A position of application of the pressure may be calculated via voltage divider measurements at conductive connections to the upper layer and the lower level.

A Pushbutton switch 1402 is a type of mechanical switch that includes two-position devices actuated with a button that is pressed and released. Most pushbutton switches have an internal spring mechanism returning the button to its “out,” or “unpressed,” position, for momentary operation. Some pushbutton switches will latch alternately on or off with every push of the button. Other pushbutton switches will stay in their “in,” or “pressed,” position until the button is pulled back out.

A Selector switch 1403 generally includes an actuated with a rotary knob or lever to select one of two or more positions. Similar to a toggle switch, a selector switch may either rest in a selected position or include a spring actuated mechanism for momentary operation and return to a home position.

A Surface Acoustic Wave switch includes an ultrasound generator and an acoustically stable medium, such as a glass surface. Surface Acoustic Wave devices detect disruptions to the acoustic wave including a position of the interruption and complete an electrical circuit conducting electron flow based upon the interruption. In some embodiments, a position of the interruption may be measured and correlated with a user activation.

A multi-directional controller switch 1404 includes electrical contacts actuated by a lever free to move in more than one axis of motion based upon a mechanical force exerted on the lever.

A Proximity switch 1405 completes an electrical connection based upon activation of a sensor, such as, for example via a change in a magnetic force or a change in an electromagnetic field. Some proximity switches include a permanent magnet to actuate a sealed switch mechanism in response to close proximity of a metal object or machine part. Some embodiments of a Proximity switch may also include an electromagnetic coil in addition to the permanent magnet or in addition to the permanent magnet.

An Optical switch 1406 includes a light source, such as for example a photocell or an LED with detector to sense an interruption or reflection of a light beam.

A Temperature Activated switch includes a mechanism that completes a flow of electrical current based upon a change of temperature. Essentially, a bimetallic strip includes a strip of two metals, joined together, wherein, inherent in each metal is a respective thermal expansion rate. Each metal strip has a different thermal expansion rate, such that when one or both strips heat or cool, differing rates of thermal expansion between the two metals causes the combined metal strip to bend. The bending of the strip can then be used to actuate a switch contact mechanism. Other temperature switches use a brass bulb filled with either a liquid or gas, with a tiny tube connecting the bulb to a pressure-sensing switch. As the bulb is heated, the gas or liquid expands, generating a pressure increase which then actuates the switch mechanism.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A printer controller for generating a hardcopy artifact, the printer controller comprising:
a processor in logical communication with a digital communications network;
a main memory in logical communication with the processor, said memory storing executable software, the software operative with the processor to cause the printer controller to:
receive via the digital communication network a selection of a unique Geospatial Designation from a Geospatial Designation Identifier device in logical communication with the digital communications network;
associate a Geographic Area with the Geospatial Designation;
generate a Boundary for the Geographic Area associated with the Geospatial Designation;
generate an association of the Boundary for the Geographic Area with a parcel of interest of a Person;
associate a first data layer with the Geographic Area, wherein the first data layer comprises data fields of alphanumeric data, associated with the Geospatial Designation;
correlate the Person with an address for receiving a hard copy delivery; and
generate the hardcopy artifact comprising data from the first data layer related to: the Boundary, a template and the Parcel.

2. The printer controller of claim 1, wherein the selection of the unique Geospatial Designation from the Geospatial Designation Identifier device comprises a Cartesian Coordinate calculated via a Global Positioning Device in a mobile phone.

3. The printer controller of claim 2, wherein the printer controller is further caused to perform a logical calculation on data included in the first data layer.

4. The printer controller of claim 3, wherein the logical calculation of data included in the first data layer is used to calculate a distance between the parcel and an amenity.

5. The printer controller of claim 4, wherein the distance calculated is a driving distance.

6. The printer controller of claim 4, wherein the logical calculation further determines a calculated driving time between the parcel and the amenity.

7. The printer controller of claim 4, wherein the distance calculated is a driving distance; and wherein a path used between the parcel and the amenity is based upon historical driving patterns between the parcel and the amenity.

8. The printer controller of claim 7 wherein a driving time is calculated based on historical driving times along an optimal path between the parcel and the amenity.

9. The printer controller of claim 1, wherein the printer controller receives an alphanumeric identifier of the Template to be referenced in the generating of the artifact.

10. The printer controller of claim 1, wherein the printer controller is further caused to generate the template based upon input from a User and execution of a logical calculation on data in the first data layer.

11. The printer controller of claim 1, wherein the printer controller is further caused to:
provide instructions to submit the hardcopy artifact for delivery to the Person.

12. The printer controller of claim 1, wherein the printer controller is further caused to:
generate an invoice based upon the hardcopy artifact generated and the address receiving the hard copy delivery.

13. The printer controller of claim 1, wherein the printer controller is further caused to:
generate a Digital Artifact including the template, data included in the first data layer, information about the parcel, and the Boundary related information.

14. The printer controller of claim 1, wherein the Geographic Area comprises a real estate parcel.

15. The printer controller of claim 1 wherein an amenity of a record of the first data layer comprises a description of a natural resource.

16. The printer controller of claim 1 wherein an amenity of a record of the first data layer comprises a resource of a business district.

17. The printer controller of claim 1 wherein an amenity of a record of the first data layer comprises a public service.

18. The printer controller of claim 17 wherein the amenity of the record of the first data layer comprises a public bus route.

19. The printer controller of claim 18 wherein the printer controller is further caused to generate a Digital Artifact including the template, data included in the first data layer, information about the parcel, and the Boundary related information, wherein the data included in the first data layer includes points along a transportation route upon the Digital Artifact.

20. The printer controller of claim 1 wherein an amenity of a record of the first data layer comprises a public attraction.
